(19) United States
(12) Patent Application Publication
(10) Pub. No.: US 2007/0082319 A1
(43) Pub. Date: Apr. 12, 2007

(54) JAW RETENTION DEVICE AND METHOD PROVIDING THE SAME

(75) Inventors: Thomas G. Fletcher, Denver, CO (US); Paul F. Fletcher, Town and Country, MO (US)

Correspondence Address: MARTIN & HENSON, P.C., 9250 W 5TH AVENUE, SUITE 200, LAKEWOOD, CO, 80226, US

(73) Assignee: HYT SYSTEM, LLC, Denver, CO (US)

(21) Appl. No.: 11/163,270

(22) Filed: Oct. 12, 2005

(51) Int. Cl. A61C 5/00

(52) U.S. Cl. 433/140

(57) ABSTRACT

Provided is a jaw retention device and a corresponding method for retaining an individual's jaw in an open position during dental procedures. In its various embodiments, the device incorporates a mouthpiece and a handhold object which are interconnected by an elongate member. Both the handhold object and the mouthpiece may be moveably disposed about respective first and second end portions of the elongate member to allow the device to be selectively oriented as desired during use.

### BACKGROUND

A dental appointment is generally not regarded as an enjoyable experience. Irrespective of whether one visits the dentist for a routine check-up such as a teeth cleaning or a more complicated procedure, the experience is often dreaded. This sentiment is shared by many adults and children alike who tend to view dental appointments as a mild form of torture, featuring medical instruments such as probes, forceps, pliers, and drills.

In order to alleviate these anxieties, dentists, hygienists, and other dental-care professionals do their best to relieve the nagging sense of general discomfort patients feel. These days, dentists strive hard to ease a patient's pain and distract the patient from the procedure at hand, including performing magic tricks. Industry professionals are also exploring ways of performing more comfortable procedures that require less intimidating medical instruments.

Throughout most of the duration of one's visit in the dental chair, it is necessary for the patient to keep his/her mouth in an open position to permit the dentist to have access to the patient's teeth. This can become quite an arduous task during prolonged dental procedures. This is in part due to the fact that jaw muscles are bio-functional for having strength in closing the mouth as opposed to opening the mouth. Inevitably, the patient's mouth has a tendency to return to its normally closed position to relieve stress on the jaw muscles for over-extended periods of opening. Unfortunately, this interferes with the dentist's access to the patient's mouth and can complicate the dental procedure or even result in unnecessary injury to the patient.

In the past, dentists have employed rubber inserts that are wedged between the patient's upper and lower rows of teeth to retain the mouth open. Until removal or repositioning of the inserts, however, the patient is unable to close his/her mouth, even when the dentist isn't working on the patient's teeth. The patient begins to feel helpless due to this lack of control over jaw movement. This can be psychologically distressing to many. It is also not uncommon for the patient's jaws to become quite sore as a result of muscle stress that is exacerbated by the patient's tendency to clench down on the rubber inserts while dental work is being performed.

It is believed that a more effective and patient friendly device available to dentists and patients to relieve muscle stress during prolonged procedures is through the use of a jaw retention device, as described in U.S. Pat. No. 6,030,217. This patent describes a handhold object and a mouthpiece that are interconnected by a flexible member such as string. The mouthpiece engages the patient's lower teeth so that when tension is applied to the flexible member via the handhold object, the patient's mouth is urged open. This device is effective and gives control back to the patient.

There are circumstances where the dentist needs access to different areas of the mouth at different times. For example, during a teeth cleaning procedure the dentist needs to address each tooth for various reasons: scaling, flossing, polishing, inspecting, etc. Accordingly, there is a need for a retention device that, similar to U.S. Pat. No. 6,030,217, can be conveniently repositioned to allow the dentist unfettered access to different areas of the mouth. Coupled with this is an additional need to allow the patient to conveniently re-orient the handhold object, particularly in a manner which does not interfere with the orientation of the mouth piece, thereby providing added flexibility to the patient from a comfort standpoint while at the same time not disrupting the dentist's procedure. The present invention is directed to meeting these needs, among others.

### SUMMARY

In order to alleviate some of the stress and discomfort associated with a visit to the dentist's office, a jaw retention device is provided that allows a patient to manually maintain his/her jaw in an open position thereby relieving the stress on the jaw muscles. This provides the patient with a sense of control in a situation that can otherwise be intimidating or simply unwelcome.

The general design of the jaw retention device, which can also be considered as a jaw retraction device, incorporates an elongate member with a first end portion and an opposite second end portion. A handhold object is moveably disposed about the first end portion and the second end portion is configured as a mouthpiece to engage an individual's teeth. The elongate member, mouthpiece, and handhold object may be constructed of any suitable material such as plastic. The material may be of either a flexible or a rigid nature. In the case of the mouthpiece, a clear plastic has the advantage of allowing the dentist to see the patient's teeth during dental procedures.

The mouthpiece can assume a variety of configurations and may be integrally molded with the elongate member or attached with a suitable adhesive. For example, the mouthpiece can have a proximal end joined to the second end portion of the elongate member and extend arcuately from the proximal end to terminate in a distal end portion. Alternatively, the mouthpiece's proximal end may be flattened and extend toward an arcuate distal end portion. It is preferable that the distal end portion include an edge adapted to engage between the individual's teeth in order to maintain the mouthpiece in a desired position. In any case, the mouthpiece is adapted to engage the individual's teeth whereby tension applied to the elongate member acts to urge the individual's jaw into the open position.

The handhold object is rotatably disposed about the elongate member such that it can be easily repositioned independently of the mouthpiece and without disturbing the location of the mouthpiece. To this end the mouthpiece may also be rotatably disposed about the elongate member. Advantageously, the handhold object may include at least one opening adapted to receive the individual's finger(s). In one embodiment of the handhold object, the opening includes a plurality of finger receiving recesses. In addition, the handhold object may be configured to resemble a variety of shapes such as an annulus, an anchor, a heart, or a cardioid.

A method of retaining an individual's jaw in an open position is also provided for use with a jaw retention device such as discussed above. According to the method, the individual's teeth are engaged by the mouthpiece and the handhold object is grasped by the patient. Tension is then applied to the elongate member to urge and retain the jaw open. Conveniently, the handhold object may be rotated independently of the mouthpiece to a desired orientation. Of course, aspects of the broad methodology steps can be performed in any suitable sequence, as will be appreciated from the following description. These and other aspects of the jaw retention device will become more readily appreciated and understood from a consideration of the following detailed description of the exemplary embodiments when taken together with the accompanying drawings in which:

### BRIEF DESCRIPTION OF THE DRAWINGS

FIG. 1 is a side view in elevation of an individual supported in a reclined position in a dentist's chair and showing the individual employing a jaw retention device for urging the individual's jaw into an open position;

FIG. 2 is an enlarged view of FIG. 1 illustrating representative placements of the jaw retention device's mouthpiece engaged on an individual's teeth;

FIG. 3 is an enlarged perspective view of the jaw retention device of FIG. 1 further illustrating the rotatability of the handhold object;

FIG. 4A is an enlarged perspective view of the individual's right hand grasping the handhold object in a first orientation;

FIG. 4B is an enlarged perspective view similar to FIG. 4A where the individual is using his index finger to grasp the handhold object in a second orientation where the handhold object is rotated;

FIG. 5 is an enlarged partial cross-section showing the mounting of the handhold object to the jaw retention device;

FIGS. 6A-C illustrate alternative constructions for the jaw retention device handhold object;

FIG. 7 is a side view in elevation of the mouthpiece illustrating one possible means of attaching the mouthpiece to the elongate member;

FIG. 8A is an enlarged perspective view of another embodiment of the jaw retention device being grasped in the individual's hand;

FIG. 8B is an enlarged perspective view similar to FIG. 8A where the individual is engaging the handhold object with two forefingers in a rotated orientation;

FIG. 9 is a perspective view of an embodiment of the jaw retention device where both the handhold object and the mouthpiece are rotatable disposed at opposite ends of the elongate member;

FIG. 10 is an enlarged cross-sectional view of the distal end portion of the mouthpiece as seen about lines 10-10 in FIG. 9;

FIG. 11 is an enlarged perspective view of the distal end portion of the mouthpiece;

FIG. 12 is a side view of the jaw retention device of FIG. 9 illustrating the attachment angle of the mouthpiece to the elongate member; and

FIG. 13 is a cross-sectional top view of the mouthpiece viewed from about lines 13-13 in FIG. 12.

### DETAILED DESCRIPTION

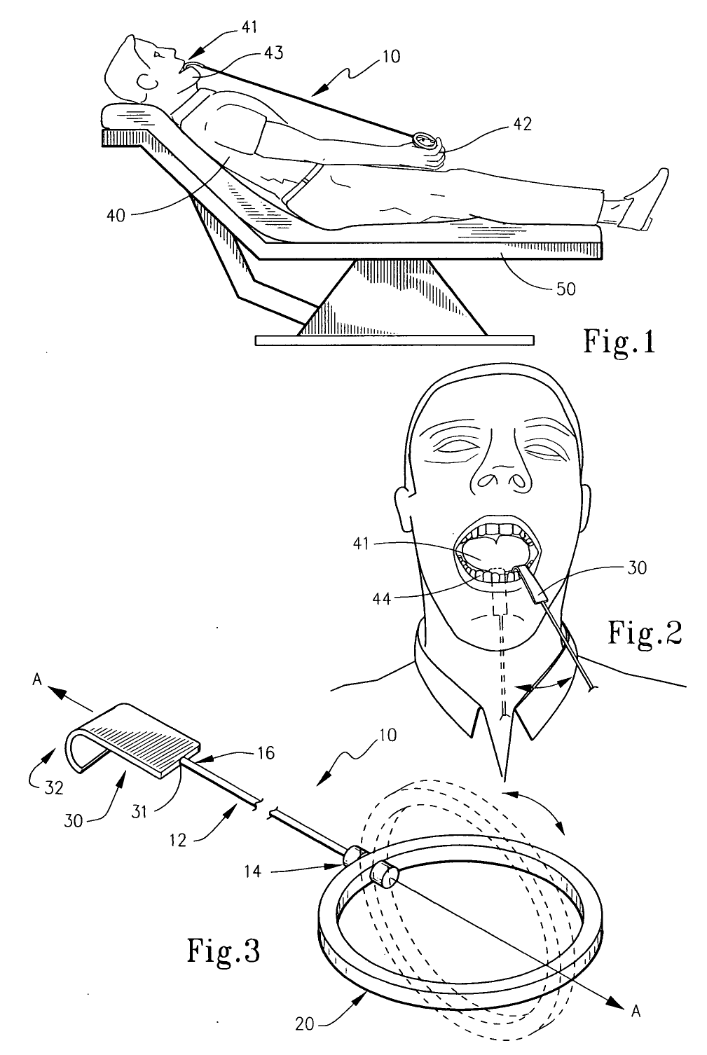

FIG. 1 shows a jaw retention device 10 according to one embodiment being used by an individual 40 while reclined in a dentist's chair 50. The jaw retention device 10 is adapted to be inserted into the patient's mouth 41 and grasped by the patient's hand 42 to urge the patient's jaw 43 into an open position. During certain dental procedures, for instance a teeth cleaning, it may be necessary to relocate the device's mouthpiece 30 on the patient's teeth 44 to allow access to different parts of the mouth 41. FIG. 2 illustrates in more detail the engagement of a mouthpiece 30 with the individual's lower teeth 44. This figure also illustrates (in phantom) relocation of the jaw retention device's mouthpiece 30 into a central position.

The construction of jaw retention device 10 according to the first embodiment may be better appreciated with initial reference to FIG. 3. This embodiment of a jaw retention device is broadly comprised of an elongate member 12, a handhold object 20, and mouthpiece 30. The elongate member 12 extends along an axis “A” between a first end portion, generally 14, and an opposite second end portion, generally 16. The handhold object 20 is disposed on first end portion 14 and is rotatable about axis “A”. Handhold object 20 is adapted to be grasped by the patient during use. The mouthpiece 30 extends from, and may be integrally molded with end portion 16 so that it is adapted for insertion into the patient's mouth 41. As such, when tension is applied to the elongate member 12 the patient's jaw 43 is urged into the open position, as is shown in FIGS. 1 and 2. Both the mouthpiece 30 and the handhold object 20 may be made of any suitable material such as plastic, and preferably a clear polycarbonate plastic. A preferred material is known in the industry by the trade name Lucite®.

The mouthpiece 30 extends arcuately from a proximal end 31, that is attached to the second end portion 16, to terminate in a distal end portion 32. The mouthpiece may be attached to the elongate member in a variety of ways. For example, FIG. 7 shows the mouthpiece 30 attached to an elongate member 12′ by the use of a suitable bonding adhesive 33, such as methyl ethyl ketone or cyanoacrylate.

The elongate member 12 may be constructed of any suitable material, for example plastic, and preferably acrylonitrile styrene acrylester. Furthermore, the elongate member 12 can be flexible or rigid. Preferably, it is sufficiently rigid to allow the patient to reposition the mouthpiece 30 on the patient's lower teeth 44 as shown in FIG. 2 by manipulating the handhold object 20. At the same time, it is advantageous to have some flexibility in the elongate member 12 in order to allow the dentist to conveniently move the mouthpiece 30 during dental procedures to various locations to permit access to different areas of the patient's mouth without necessarily relying on the patient to either move the mouthpiece or the handhold object.

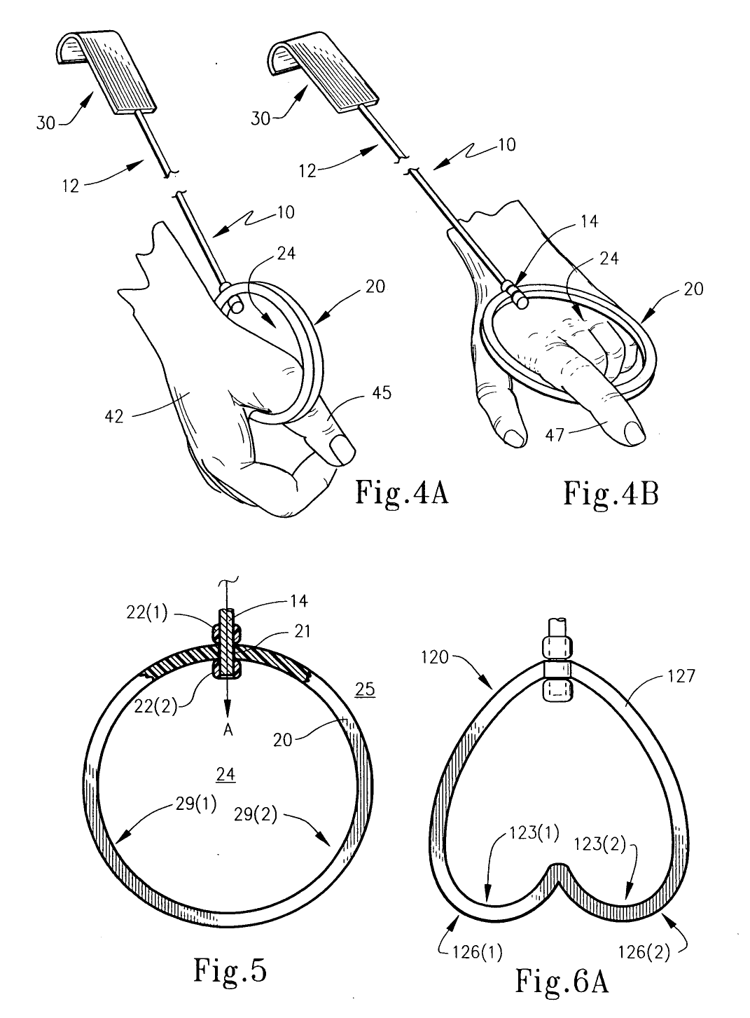

Referring again to FIG. 3, the rotatability of handhold object 20 about the elongate member 12 and axis “A” allows the patient 40 to reposition his/her hand 42 to a comfortable position without disturbing the positioning of the mouthpiece 30. The rotatability of the handhold object 20 facilitates various grasping positions, two of which are illustrated in FIGS. 4a and 4b for representative purposes. In these figures, as in earlier figures, the handhold object 20 is configured generally as an annular member having a central opening 24. FIG. 4a illustrates the patient grasping the handhold object 20 by placing the thumb 45 of the right hand 42 through opening 24. FIG. 4b, on the other hand, shows another grasping position in which the patient has inserted his/her index finger 47 through opening 24 causing the handhold object to rotate about the first end portion 14 to an equilibrium position.

FIG. 5 details one possible construction for rotatably attaching the handhold object 20 relative to the first end portion 14. In this embodiment the first end portion 14 is inserted through a bore 21 formed through handhold object 20. Retainers 22(1) and 22(2) are respectively disposed interiorly 24 and exteriorly 25 of the handhold object 20 in a sandwiched arrangement such that the elongate member is held in place axially yet allowed to rotate about the elongate member 12. The retainers 22(1) and 22(2) can be mounted in various ways, such as by gluing or melting them to the elongate member's first end portion 14. To this end the retainers 22(1) and 22(2) are also preferably constructed from a suitable plastic material.

The artisan will appreciate that there may be many ways to rotatably attach the handhold 20 to the elongate member 12 beyond the manner illustrated for example in FIG.5. For example, the retainers could be integrally molded with the elongate member 12 such that the handhold 20 is configured to have separable wings 29(1) and 29(2) so that it can be snapped over the retainer 22(2) to prohibit axial movement, while still allowing rotation. The retainers could also be integrally molded where retainer 22(2) is formed with a taper whereby retainer 22(2) could be snapped through the handhold object's, bore 21. The handhold object could also be attached with a ball and socket joint or a universal joint. Regardless of the particular construction adopted, though, it is desirable that the handhold object 20 be mounted in a manner that permits it to freely rotate independently of the elongate member 12, and particularly the first end portion 14 thereof.

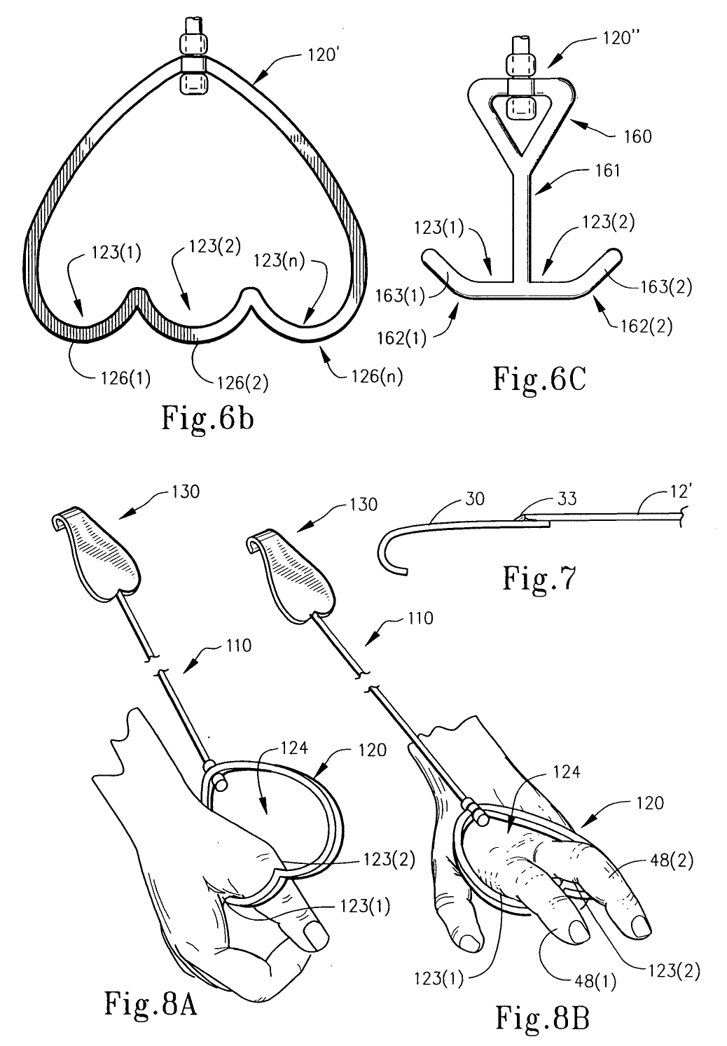

The handhold object can, of course, assume a variety of different shapes other than the annular shape best shown in the embodiments of FIGS. 1 and 3-5. FIGS. 6a-6c illustrate various other handhold configurations that incorporate finger recesses, generally 123. FIG. 6a, for example, shows a heart or cardioid shaped handhold object 120 that includes two finger receiving regions 123(1) and 123(2) formed from lobed portions 126(1) and 126(2), respectively, of the surrounding sidewall 127. FIG. 6b illustrates an alternative construction wherein the handhold object 120′ may have any suitable number of finger receiving regions 123(1)-123(n) formed by lobes 126(1)-126(n) respectively. As is illustrated in FIG. 6c the handhold object 120″, in this case an anchor configuration, need not have an opening in order to provide finger receiving regions 123. The anchor handhold 120″ includes an eye 160, a central shank 161, and a pair of arms 162(1) and 162(2). The arms 162(1) and 1 62(2) extend in opposite directions on both sides of the shank 161 and preferably include upwardly diverging extensions 163(1) and 163(2) for generally defining the finger receiving regions 123(1) and 123(2).

It is contemplated that an alternative embodiment for a jaw retention device could be constructed to provide visual guidance (via illumination) to the dentist during dental procedures. To this end, the jaw retention device could incorporate a light source which projects light through the mouthpiece to illuminate a region of the patient's mouth. As a representative example, although not by way of limitation, the light source (e.g., a battery powered bulb or LED) could be incorporated as part of the handhold object. The light could then be communicated through the elongate member itself, such as where the elongate member is a fiber optic cable or is formed to include a light receiving channel for transmitting the light from the handhold object to the mouthpiece. Similarly, the mouthpiece could be formed of an optically conductive material or include a channel that directs the light where desired.

FIGS. 8a and 8b illustrate another exemplary embodiment for a jaw retention device 110, here the handhold object 120 is heart shaped, as in FIG. 6a, providing two finger recesses 123(1) and 123(2) and the mouthpiece 130 may be constructed similar to that described in U.S. Pat. No. 6,030,217 which is incorporated herein by reference. FIG. 8b illustrates one way of grasping the handhold object 120 by inserting two forefingers 48(1) and 48(2) through opening 124 and engaging the two finger recesses 123(1) and 123(2).

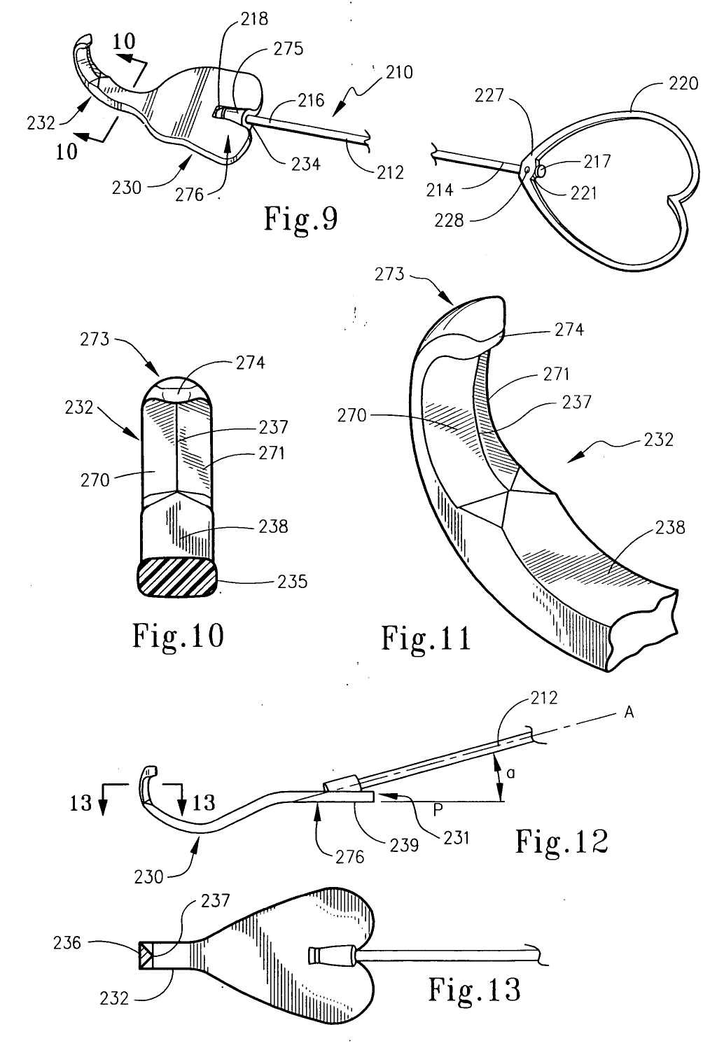

FIG. 9 shows another exemplary embodiment 210 of a jaw retention device including alternate constructions of the handhold object and mouthpiece. The handhold object is of a heart shape similar to FIG. 6a with an additional aperture 228 for alternatively permitting a string or the like to be tied to the handhold object (as in U.S. Pat. No. 6,030,217), so that the handhold object is rotatable with the first end portion. In FIG. 9 it can be appreciated that the handhold object 220 may otherwise be retained on the elongate member 212 by forming a protuberance 217 on the first end portion 214 after insertion through bore 221 formed through sidewall 227. The protuberance 217 may be formed by pressing the elongate member 212 against an anvil that is heated to a temperature sufficient to melt the elongate member's first end or by other suitable means. The resulting protuberance 217 is larger in diameter than the bore 221 thereby retaining the handhold object 220 on the elongate member by prohibiting it to pass back through the bore.

Similar to U.S. Pat. No.6,030,217, the particular construction of mouthpiece 230 in this embodiment has a flattened proximal end portion 276 joined to the second end portion 216 of the elongate member 212. Included on the flattened proximal end portion 276 is a bearing boss 275 with a bore 234 formed therethrough. As is illustrated in FIG. 12 the mouthpiece 230 is attached at an acute angle “a” to the elongate member 212. Angle “a”, which in the preferred construction shown is approximately 3-10°, is defined as the angle between the elongate member 212 and a plane “p” which contains a lower surface 239 of the flattened proximal end portion 276.

The mouthpiece 230 may be rotatably disposed about the second end portion 216 of the elongate member 212 by inserting the second end portion through bore 234 and forming a protuberance 218 thereon, thereby attaching the mouthpiece 230 to the elongate member 212 in a similar fashion as that employed in attaching the handhold object 220. Alternatively, the mouthpiece could be immovable relative to the elongate member 212 via gluing or the like.

The mouthpiece 230 arcuately extends from the flattened proximal end portion 276 towards a distal end portion 232. As is illustrated in more detail in FIGS. 10, 11 and 13, the arcuate distal end portion 232 has a generally rectangular cross-section 235 (FIG. 10) transitioning to a generally triangular cross-section 236 (FIG. 13) and finally terminating in a distal end 274 of rectangular cross-section (FIG. 11). The first rectangular cross-section portion 235 provides a comfortable surface 238 suitable to rest against the patient's lip during a dental procedure. The triangular cross-section portion 236 is formed by walls 270 and 271 which converge toward an edge 237 that can be seated between the patient's teeth thereby maintaining the desired position of the mouthpiece 230 against the patient's teeth. The second rectangular cross-section of the mouthpiece's distal end portion 273 provides a stop to help prevent the mouthpiece from slipping off of the patient's teeth during use, while also providing a blunt distal end 274 to prevent injury or discomfort to the patient.

To provide additional comfort to patients such as those with chipped or sensitive teeth, the arcuate distal end portion 232 may be formed of a material that is relatively soft when compared to the material of the flattened proximal end portion 276. Alternatively, the distal end portion 232 may be covered with a relatively soft material that is configured as a sleeve adapted to be removeably disposed over the distal end portion 232. Alternatively, or additionally, edge 237 may be appropriately rounded to help prevent any aggravation of patients' sensitive teeth.

With the above description in mind, it should be appreciated, among other advantages, that the jaw retention device can be used to retain an individual's jaw in an open position by engaging the individual's teeth with the mouthpiece. After engaging the individual's teeth the handhold object can be grasped where tension is applied along the elongate member thereby urging the individual's jaw into an open position. The handhold object can then be rotated independently of the mouthpiece to a desired orientation. Finally, the individual's jaw can be retained in the open position simply by maintaining the applied tension.

Accordingly, the jaw retention device has been described with some degree of particularity directed to the exemplary embodiment of the device. It should be appreciated, though, that the jaw retention device is defined by the following claims construed in light of the prior art so that modifications or changes may be made to the exemplary embodiments of the jaw retention device without departing from the inventive concepts contained herein.

What is claimed is:

1. A jaw retention device, comprising:
(a) an elongate member having a first end portion and an opposite second end portion wherein said second end portion is configured as a mouthpiece adapted to engage an individual's teeth; and
(b) a handhold object moveably disposed about the first end portion.

2. A jaw retention device according to claim 1 wherein said elongate member is flexible.

3. A jaw retention device according to claim 1 wherein said elongate member is rigid.

4. A jaw retention device according to claim 1 wherein said mouthpiece is integrally molded with said elongate member.

5. A jaw retention device according to claim 4 wherein said elongate member is rigid.

6. A jaw retention device according to claim 1 wherein said mouthpiece is adhered to said elongate member.

7. A jaw retention device according to claim 1 wherein said handhold object is rotatably disposed about the first end portion.

8. A jaw retention device according to claim 1 wherein said handhold object moves independently of said elongate member.

9. A jaw retention device according to claim 1 wherein said mouthpiece has an arcuate portion for engaging the individual's teeth.

10. A jaw retention device according to claim 1 wherein said handhold object includes an opening adapted to receive the individual's fingers therethrough.

11. A jaw retention device according to claim 10 wherein the handhold object is configured to include a plurality of finger receiving regions.

12. A jaw retention device according to claim 1 wherein said mouthpiece is rotatably disposed about said second end portion.

13. A jaw retention device for urging an individual's jaw into an open position, comprising:
(a) an elongate member extending along a longitudinal axis between opposed first and second end portions;
(b) a handhold object disposed on said first end portion and rotatable about the longitudinal axis; and
(c) a mouthpiece disposed on said second end portion, said mouthpiece adapted to engage the individual's teeth whereby tension applied to said elongate member along the longitudinal axis urges the individual's jaw into the open position.

14. A jaw retention device according to claim 13 wherein said handhold object is configured to resemble a shape selected from a group consisting of: an annulus, an anchor, and a heart.

15. A jaw retention device according to claim 13 wherein said handhold object has a plurality of finger receiving regions.

16. A jaw retention device according to claim 1 3 wherein the longitudinal axis extends centrally through the elongate member.

17. A jaw retention device according to claim 16 wherein said elongate member is flexible.

18. A jaw retention device according to claim 1 3 wherein said handhold object is moveable independently of said elongate member.

19. A jaw retention device adapted for use by an individual to urge the individual's jaw into an open position, comprising:
(a) an elongate member having opposed first and second end portions;
(b) a handhold object rotatably journaled about, and independently of, said first end portion; and
(c) a mouthpiece having a proximal end joined to said second end portion and arcuately extending from said proximal end to terminate in a distal end.

20. A jaw retention device according to claim 19 wherein said handhold object is rotatably journaled on said first end portion.

21. A jaw retention device according to claim 19 wherein said mouthpiece is constructed of plastic.

22. A jaw retention device according to claim 19 wherein said mouthpiece is constructed of clear plastic.

23. A jaw retention device according to claim 19 wherein said proximal end is flattened and said distal end portion is arcuate.

24. A jaw retention device according to claim 23 wherein a distal end portion of said mouthpiece includes an edge adapted to seat between the individuals teeth during use.

25. In a jaw retention device that includes an elongate member extending between opposed first and second end portions, a handhold object disposed on the first end portion of said elongate member and moveable therewith, and a mouthpiece disposed on the second end portion and adapted to engage the individual's teeth whereby tension placed on said elongate member urges the individual's jaw into the open position, the improvement comprising said handhold object being rotatably disposed relative to the first end portion.

26. The improvement according to claim 25 wherein said mouthpiece is rotatably disposed relative to said second end portion.

27. A method of retaining an individual's jaw in an open position comprising:
providing an elongate member having opposed first and second end portions, there being a handhold object rotatably disposed on the first end portion, and a mouthpiece disposed on the second end portion;
engaging the individual's teeth with said mouthpiece;
grasping the handhold object;
applying tension on said elongate member to urge the individual's jaw into an open position;
rotating the handhold object independently of said mouthpiece about the first end portion to a desired orientation; and
maintaining said tension to retain the individual's jaw in the open position.

28. The method of clam 27 wherein said handhold object is rotated prior to applying the tension.

29. The method of claim 27 wherein said handhold object is grasped prior to engaging the individual's teeth with said mouthpiece.
